(19) United States
(12) Patent Application Publication
(10) Pub. No.: US 2012/0312939 A1
(43) Pub. Date: Dec. 13, 2012

(54) Duck web active decoy system

(76) Inventor: Travis G. Elsperger, Devils Lake, ND (US)

(21) Appl. No.: 13/134,351

(22) Filed: Jun. 7, 2011

(51) Int. Cl. F16M 11/20

(52) U.S. Cl. 248/157; 248/188.91; 248/188.8

(57) ABSTRACT

A simple structure which can be used to raise the visibility and realism of any motion or stationary game animal artificial decoy by attaching said decoys to nearly transparent or low profile material which is suspended from an anchored structure in order to entice more game animals into kill range.

### BACKGROUND

There are currently many devices used by game (i.e. duck, goose, crane, deer, turkey) hunters to entice their desired game into range. Present day apparatus employed to suspend motion or stationary decoys, for the most part, consist of a staking system that visibly attaches directly to the said decoy creating detection (by desired game) problems on high visibility days (i.e. sunny, no wind weather). On days when visibility is low (i.e. cloudy, windy, or foggy) the present day staking systems do work very well. Game animals are constantly evolving and hunters that pursue these game animals must also evolve the methods they deploy in order to continue to fool these game animals to enter into range. One current trend is the use of motion decoys that feature spinning or rotating body parts that mimics the movements of game animals. As stated earlier, these methods work very well when visibility is poor and the approaching game animals cannot see very well. Unfortunately, all days are not low visibility days and a way to conceal the motion decoy support structure differently from what is currently in use is needed.

### SUMMARY

The object of the invention is to solve the problems of lowering the visibility of the support structures employed to suspend or support motion or stationary game animal decoys in order to lessen the probably of the detection of said support systems by the game animal being pursued. The invention utilizes the support of vertical metal structures and low visibility line or wire to suspend motion and stationary decoys over a selected area in order to entice game animals into range. The structure removes a highly visible stake or metal object leading directly to the decoy and widens the distance in which the main support structure is located from the frame of view of the selected game animal and utilizes a secondary support to attach directly to the motion or stationary decoy in order to create the illusion of zero external attachments. The invention also raises the elevation at which the decoy may be deployed to drastically improve the visibility of the decoy itself to prospective game animal targets. Finally, the invention adds secondary movement in three dimensions in addition to the primary movement of the motion or stationary decoy with the flexibility of the secondary support structures.

### BRIEF DESCRIPTION OF DRAWINGS

Having described the invention in general terms and discussing its purpose, reference will now be made to the accompanying drawings, which are not necessarily drawn to scale, wherein:

FIG. 1 is a perspective illustration of the invention depicting it with one motion decoy in use.

FIG. 2 is the overall metal structure of the invention and is the primary support of the purpose of the invention.

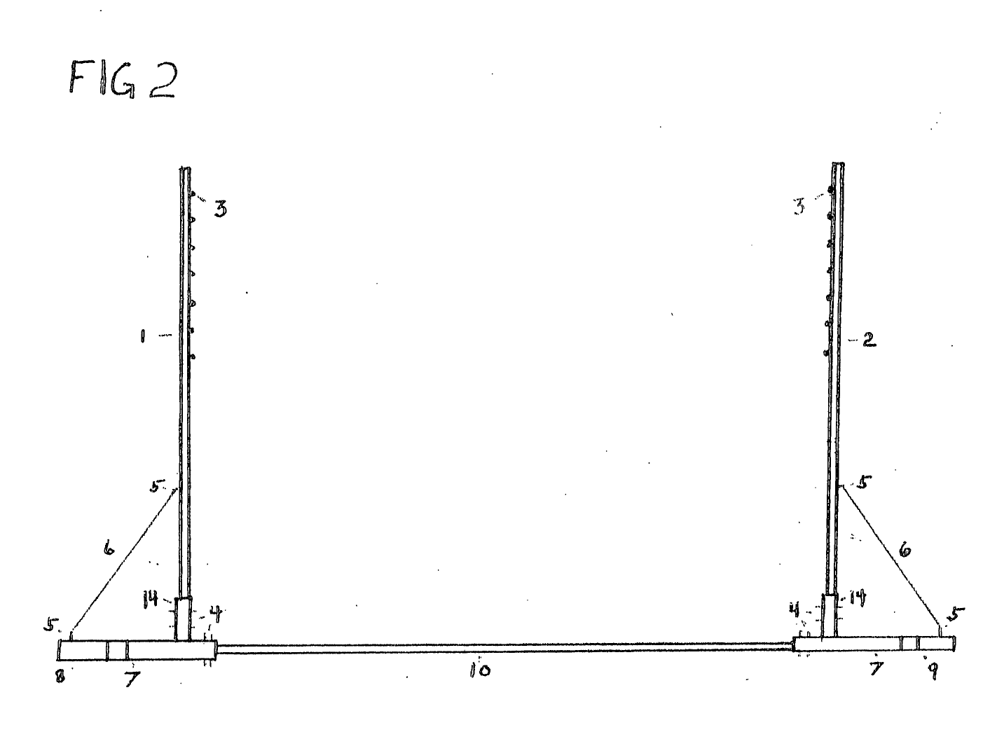

FIG. 3 is a close-up of a side view of the left base of the invention. The inventions right base is an exact copy in reverse.

FIG. 4 is a close-up top view of the inventions left base. The inventions right base is an exact copy in reverse.

FIG. 5 illustrates a ‘single support option’ of the invention that can be utilized without erecting the second vertical primary support.

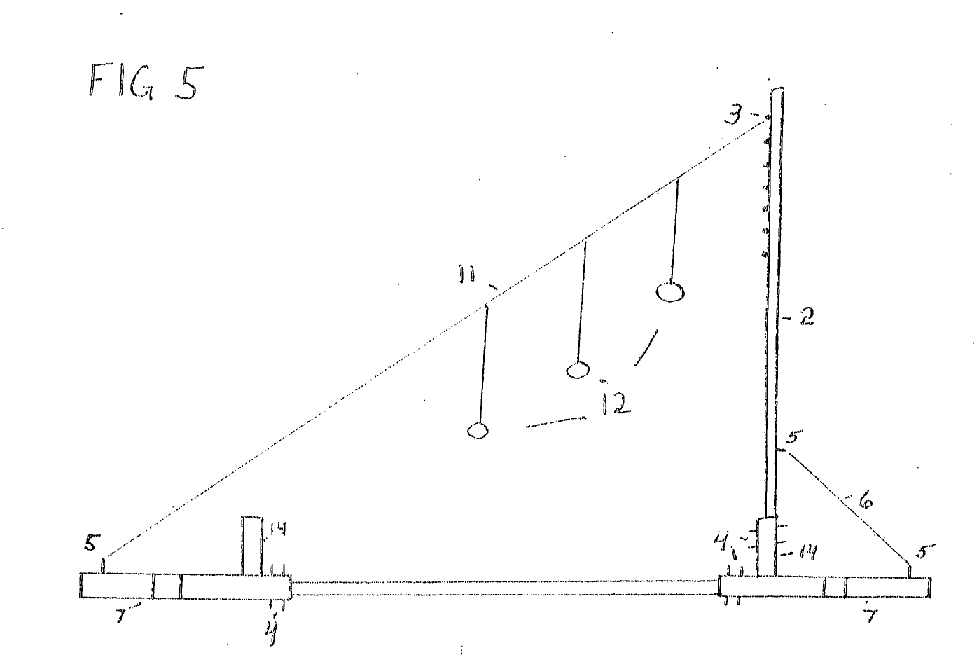

FIG. 6 is the primary and secondary supports and the standard configuration for displaying decoys at various levels of elevation.

FIG. 7 is the primary and secondary supports and the most basic configuration of the secondary supports.

### DETAILED DESCRIPTION

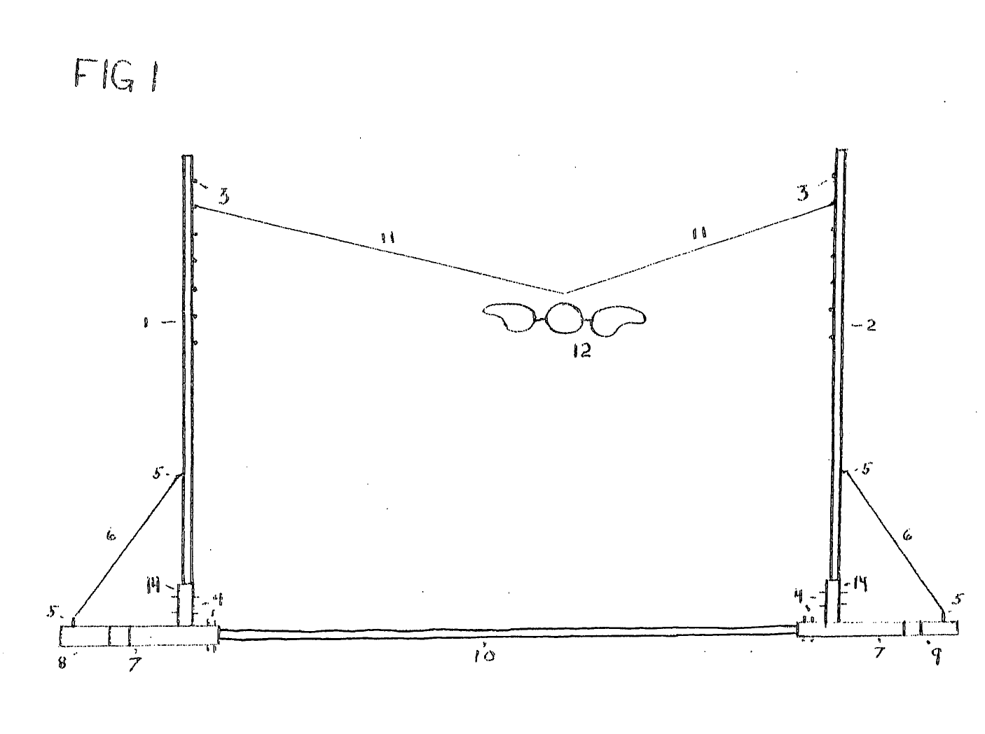

FIG. 1 shows the invention in its entirety, a structure to elevate and suspend a variety of game animal decoys off of the ground without plainly visible supporting structures leading directly to the decoy itself and to increase the visibility to enhance the effectiveness of said decoy/decoys.

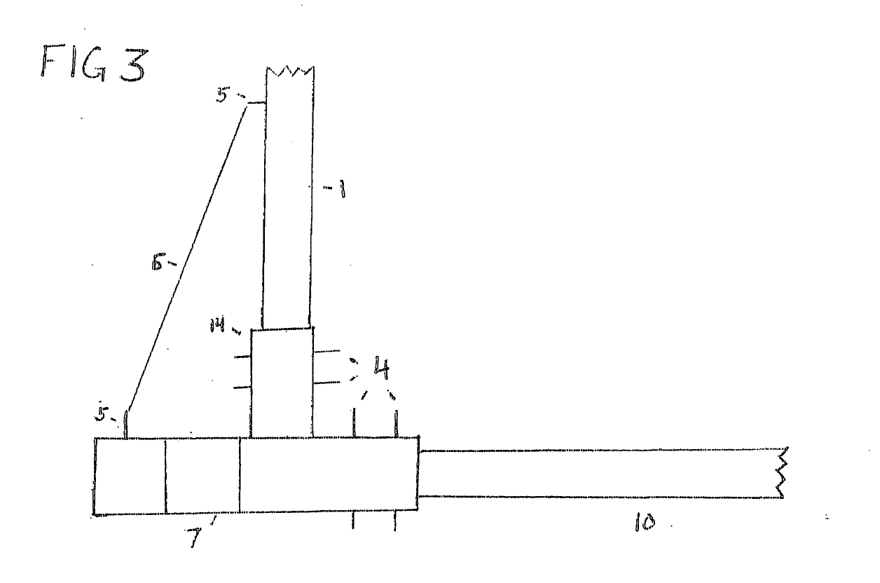

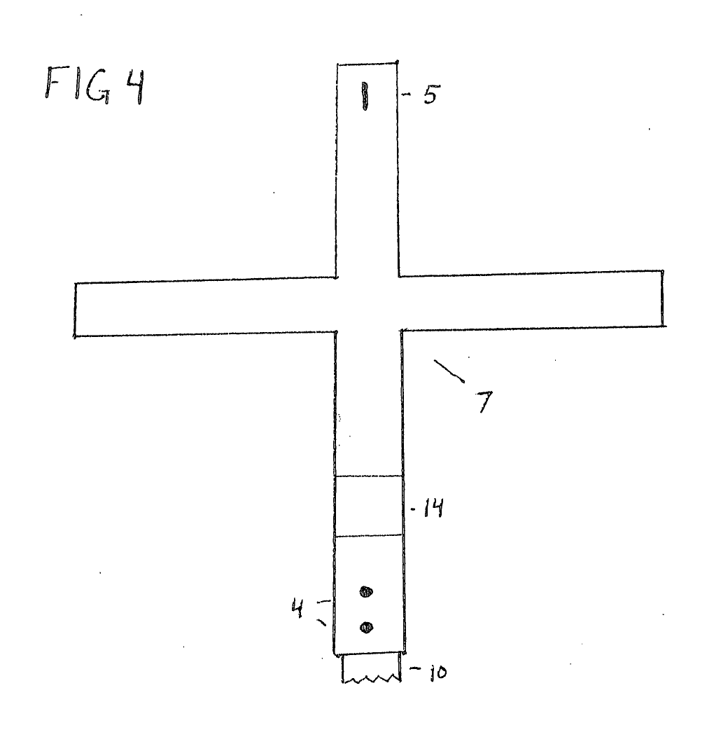

The structure consists of a horizontal base connector 10 that runs parallel to the ground and connects the left base 8 and the right base 9. The horizontal base connector 10 is a length of rigid metal tubing no less then 6 ft and no more than 20 ft long and in a diameter/width small enough so that it can be inserted into both the left base 8 and the right base 9 (FIG. 3). The left base 8 and right base 9 are identical t-bars 7 (FIG. 4) constructed of rigid metal tubing consisting of two perpendicular lengths of tubing welded at their intersection 13. The tubing that constructs the left base 8 and right base 9 is of a diameter/width to accommodate the insertion of the horizontal base connector 10 to a distance of at least one foot. The horizontal base connector 10 is inserted in both the left base 8 and right base 9 to a distance of no less than 1 foot and secured with fasteners 4 that are inserted through matched holes on the left base 8 and right base 9 and the horizontal base connector 10 (FIG. 3). The fasteners 4 are of rigid metal and a length that allows for them to sufficiently extend past the exiting hole. The left base 8 and right base 9 have on their top surface a vertical primary support slot 14 welded at a position that is slightly towards the center of the entire structure.

The primary support slot 14 is constructed of the same diameter/width rigid metal as the left base 8 and right base 9 in order to accommodate the insertion of the left vertical primary support 1 and the right vertical primary support 2.

The left vertical primary support 1 and the right vertical primary support 2 are lengths of rigid metal tubing no shorter than 6 ft and no longer than 20 ft constructed of the same diameter/width rigid metal tubing as the horizontal base connector 10 so as to make it possible to insert the left primary vertical support 1 and the right primary vertical support 2 into the vertical primary support slots 14. The left vertical primary support 1 and the right vertical primary support 2 are slid into the vertical primary support slots 14 and secured with fasteners 4 that are inserted into matched holes on the vertical primary support slot 14 and the left vertical primary support 1 and the right vertical primary support 2. Located on the outer edge of both the left base 8 and the right base 9 are anchor wire attachments located no less than 2 inches from the outer edge and no more than 10 inches from the outer edge of both bases.

The left vertical primary support 1 and the right vertical primary support 2 both have secondary support attachment points 3 along the interior edge at varying intervals. The vertical primary supports 1 and 2 also both have anchor wire attachments 5 on their outer edges no less than 2 ft and nor more than 5 ft up from the location of the meeting of the vertical supports 1 and 2 and the vertical support slots 14.

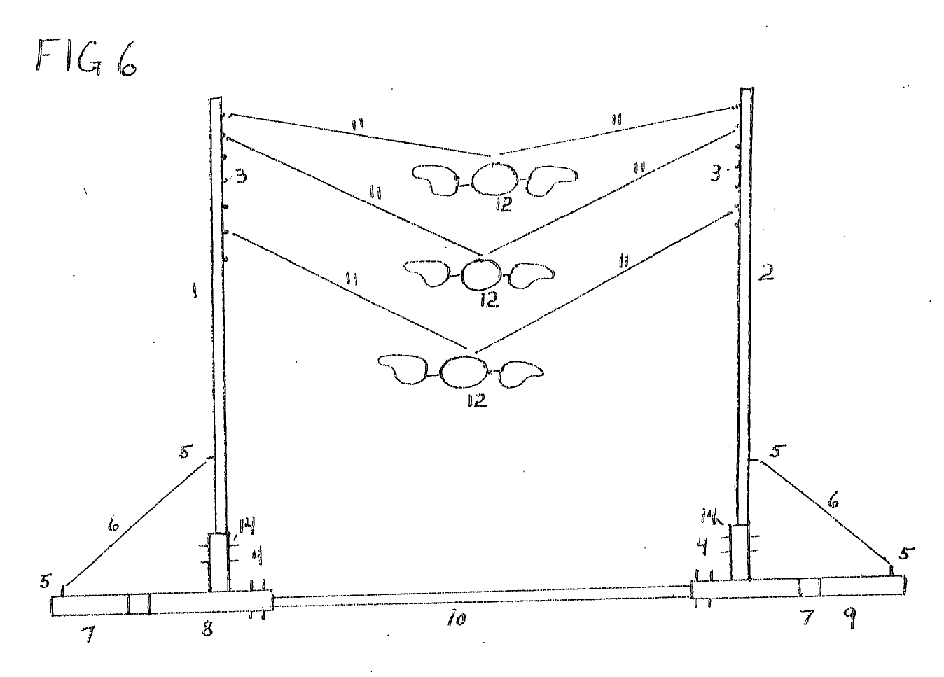

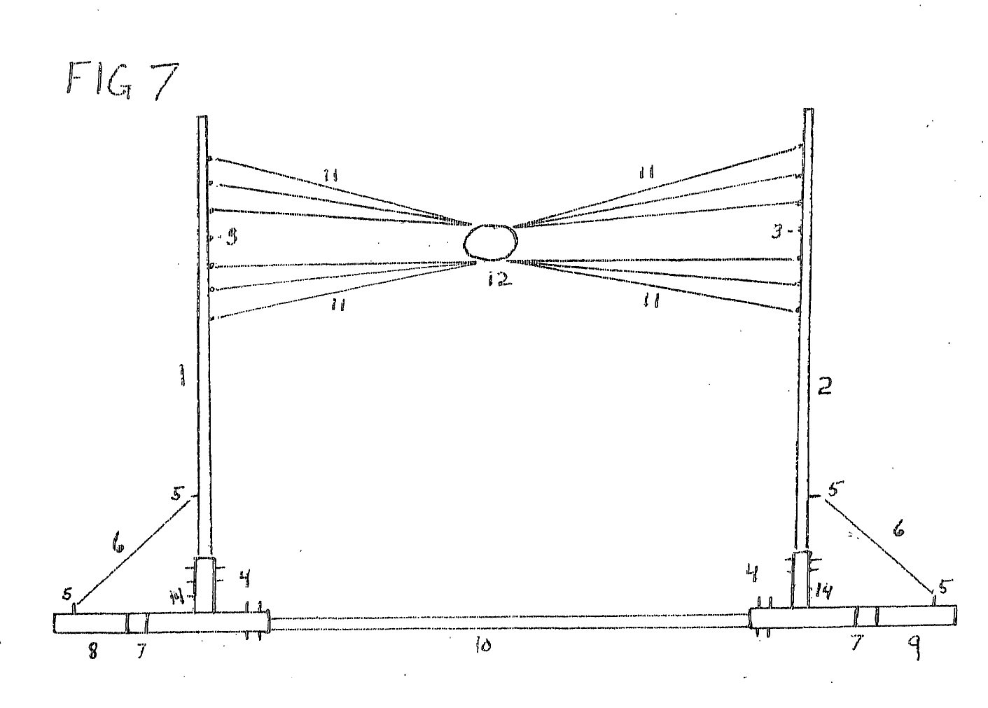

The secondary support attachment points 3 are the location where the low visibility line/wire 11 attaches to the vertical primary supports 1 and 2. The number of configurations and combinations of low visibility line/wire 11 to various designs of motion/stationary decoys 12 are numerous and not feasible to list every example so included are FIG. 6 and FIG. 7 with typical examples.

What I claim as my invention is:

1. A support structure, comprising: multiple vertical primary supports of a size capable of being compatible with the horizontal base connector, one or more horizontal base connectors of a size to be compatible with the vertical primary support, variable attachment points along the vertical primary supports to receive the secondary supports, and multiple stability structures, composing a structure no shorter than three feet and wider than six feet with a mass that allows the structure to be moved by human power.

2. The support structure of claim 1, further comprising variable attachment points along the horizontal base connector to receive secondary support structures and add on accessories.

3. The support structure of claim 1, further comprising secondary supports which can be but are not limited to variable mediums of near zero visibility.

4. The support structure of claim 1, further comprising fasteners at compatibility points to facilitate construction.

5. The support structure of claim 1, further comprises secondary support locations that are removable, modifiable, and movable through the application of fasteners.

6. A support structure, comprising: multiple vertical primary supports constructed of low visibility, flexible, and durable material.

7. The support structure of claim 6, further comprises secondary supports of near zero visibility material.

8. The support structure of claim 6, comprising of multiple vertical primary supports and secondary supports that allow flexibility to accommodate movement in three dimensions.

9. The support structure of claim 6, further comprising on or more horizontal base connectors of materials that allow flexibility so as to conform to different contours of ground placed on.

10. A support structure, comprising: variable insertion points and movable attachment points to accommodate additional connectors to additional support structures, additional support material, and additional accessories.
